(19) United States
(12) Patent Application Publication
(10) Pub. No.: US 2023/0256767 A1
(43) Pub. Date: Aug. 17, 2023

(54) Stationery Sculptures

(71) Applicant: Dwayne L. Peck, Huntington Beach, CA (US)

(72) Inventor: Dwayne L. Peck, Huntington Beach, CA (US)

(21) Appl. No.: 18/169,719

(22) Filed: Feb. 15, 2023

Related U.S. Application Data
(60) Provisional application No. 63/310,863, filed on Feb. 16, 2022.

(51) Int. Cl. B42D 15/04; G09F 1/04

(52) U.S. Cl. CPC B42D 15/045; G09F 1/04; G09F 1/10

(57) ABSTRACT

A combination greeting card and sculpture deliverable as a single unit in a package with a greeting card inserted into the package. A holder attached to the greeting card, the package or both the greeting card and the package with one or more than one piece of art personalized to the recipient that is attachable and detachable from the greeting card. And, optionally, one or more than one art stand attachable and detachable from the greeting card for supporting the one or more than one piece of art.

### CROSS-REFERENCE TO RELATED APPLICATIONS

This application claims the benefit under 35 U.S.C. § 119(e) of U.S. Provisional Patent Application Ser. No. 63/310,863 2022 Feb. 16, filed on 2022 Feb. 16, the contents of which are incorporated herein by reference in their entirety.

### FIELD OF THE INVENTION

The present invention is in the technical field of greeting cards and more particularly to a combination greeting card and sculpture deliverable as a single unit.

### BACKGROUND

Americans purchase approximately 6.5 billion greeting cards each year. However, the initial “wow” moment created by a recipient of the greeting card is soon over.

All the currently available types of cards: sentimental cards, greeting cards, sympathy cards, holiday cards, etc., have yet to find a solution to the very nature of the greeting cards themselves. Most cards, regardless of how elaborate or meaningful, if placed on a viewable location in either a personal space or office setting, will inevitably experience a limited shelf life. Paper cards of all varieties are removed from the public space where, for some reason, the greeting cards just seem out of place over time.

Occasionally, the greeting cards are placed into a private place where you store important memorable experiences of your loved ones and friends, locked away only to be seen when the mood strikes you or entirely by accident, or they are thrown away since whatever emotion or purpose they created had dissipated with time. In short, the greeting card is removed from where it once was rarely to been seen or experienced again. Commercially produced cards are rarely placed in long term storage, but are almost universally thrown away or discarded after a short time. Even elaborate and special cards, are still just a card and not known as a keepsake.

U.S. Pat. No. 9,842,516B2, titled “Article with removable three-dimensional object”, assigned to LovePop and U.S. Pat. No. 9,475,333B2, titled “Article with removable three-dimensional object”, assigned to LovePop, attempted to overcome the limitations of the past. These inventions are designed around a paper card that, when opened, has an origami like 3D structure pop out of the middle of the greeting card 102. The process of having a 3D structure is not new, as Origami has been around since the 17^{th} century, but the implementation was determined to be novel for the greeting card industry.

However, the problem with any type of paper object, like those above, is the fragility, temporary, and disposable nature of the object. It is still paper, no matter how it is embellished. Additionally, there isn't a way of mounting the object disclosed in these references. The recipient still needs to find a way of displaying the objects.

As for the folding cards that are currently sold, the more use that they get, the more fragile and temporary the greeting card becomes. Time does not favor paper items of any type. Age and disintegration await. Colors fade along with the emotion as any saved card is placed somewhere out of sight and out of the recipients memory.

Additionally, the emotional process for writing cards should provide the emphasis and a longer lasting experience than a couple nice lines that a paper card is able to provide. Yet, those thoughts and sentiments are eventually put away or thrown away. Even if the sender wants to send a trinket or other meaningful object, there is no room for them to be placed in the envelope, nor do they often match with the intent of the greeting card 102.

Therefore, there is a need for a combination greeting card and sculpture deliverable as a single unit, overcoming the limitations of the prior art.

### BRIEF DESCRIPTION OF THE DRAWINGS

These and other features, aspects and advantages of the present invention will become better understood with regard to the following description, appended claims, and accompanying figures where:

FIG. 1 is a drawing of a combination greeting card and sculpture deliverable as a single unit, according to one embodiment of the present invention;

FIG. 2 is a second drawing of a combination greeting card and sculpture deliverable as a single unit according to another embodiment;

FIG. 3 is a third drawing of a combination greeting card and sculpture deliverable as a single unit according to another embodiment;

FIG. 4 is a fourth drawing of a combination greeting card and sculpture deliverable as a single unit according to another embodiment;

FIG. 5 is a fifth drawing of a combination greeting card and sculpture deliverable as a single unit according to another embodiment;

FIG. 6 is a sixth drawing of a combination greeting card and sculpture deliverable as a single unit according to another embodiment;

FIG. 7 is a seventh drawing of a combination greeting card and sculpture deliverable as a single unit according to another embodiment;

FIG. 8 is an eighth drawing of a combination greeting card and sculpture deliverable as a single unit according to another embodiment;

FIG. 9 is a second drawing of stand useful for the combination greeting card and sculpture deliverable as a single unit shown in FIG. 1;

FIG. 10 is a third drawing of a stand useful for a combination greeting card and sculpture deliverable as a single unit shown in FIG. 1;

FIG. 11 is a drawing of a single unit using foam to secure the art inside the greeting card;

FIG. 12 is a drawing of a single unit using an envelope to secure the art inside the greeting card;

FIG. 13 is a drawings of various frame stands useful for the combination greeting card and sculpture deliverable as a single unit shown in FIG. 1;

FIG. 14 is a drawing of a two dimensional piece of art useful for the combination greeting card and sculpture deliverable as a single unit shown in FIG. 1;

FIG. 15 is a drawing of the two dimensional piece of art shown in FIG. 14 with a stand;

FIG. 16 is a drawing of a perspective view of a stand useful for the combination greeting card and sculpture deliverable as a single unit shown in FIG. 1;

FIG. 17 is a drawing of a front view of a stand useful for the combination greeting card and sculpture deliverable as a single unit shown in FIG. 1;

FIG. 18 is a drawing of a relief charm useful for the combination greeting card and sculpture deliverable as a single unit shown in FIG. 1;

FIG. 19 is a drawing of a sculptured charm useful for the combination greeting card and sculpture deliverable as a single unit shown in FIG. 1;

FIG. 20 is a drawing of a clamp stand useful for the combination greeting card and sculpture deliverable as a single unit shown in FIG. 1;

FIG. 21 is a drawing of a second clamp stand useful for the combination greeting card and sculpture deliverable as a single unit shown in FIG. 1;

FIG. 22 is a drawing of possible placements for one or more than one piece of art removed from the combination greeting card and sculpture deliverable as a single unit shown in FIG. 1;

FIG. 23 is a drawing of a kit for making a combination greeting card and sculpture deliverable as a single unit; and

FIG. 24 is a flowchart diagram of some steps of a method for using the combination greeting card and sculpture deliverable as a single unit.

### SUMMARY

A combination greeting card and sculpture 100 deliverable as a single unit, the single unit having a package 108 for delivery, a greeting card 102 insertable into the package 108, a holder 202 attached to the greeting card, the package 108 or both the greeting card 102 and the package 108, one or more than one piece of art 104 personalized to the recipient that is attachable and detachable from the greeting card 102 that is displayed at any location for extended periods of time, and one or more than one art stand 204 attachable and detachable from the greeting card 102 for supporting the one or more than one piece of art. Optionally, the one or more than one piece of art 104 does not require a stand.

The package 108 is selected from the group consisting of a folder, an insulated envelope, an envelope, or a box.

The greeting card 102 individualizes and personalize the experience and emotion for the sender to the recipient, wherein the one or more than one piece of art 104 becomes the recipient's. The greeting card 102 is separate from the sculpture 104 and is placed at a desired location by the recipient as a reminder of emotions associated with the greeting card 102 making it more individualized and special to the recipient.

The stand 204 for supporting one or more than one piece of art 104 is selected from the group consisting of a flat surface stand, a magnetic attachment, a hanging attachment, or a self adhesive wall mount. The stand 204 is provided for each piece of art 104 that requires a stand, wherein if the piece of art 104 has two or more components that require a stand, the single unit will have a stand 204 for each piece. The stand 204 is selected from the group consisting of: a magnet, a foldable display case, a pin, a hook, hook and loop, one or more than one elastic bands, one or more than one plastic straps, one or more than one wire tie, tape 702, or an adhesive 602. The stand 204 and/or the one or more than on piece of art 104 are attached to the greeting card 102 with one or more than one hook and loop strap. The stand 204 is also a piece of art 104 to complement the one or more than one piece of art. The stand 204 is bendable/foldable to occupy the least amount of space or is collapsible to fit into a sleeve 802 attached to the greeting card 102. The stand 204 comprises one or more than one fixed joint hinge 1002 to support the one or more than one piece of art, wherein the one or more than one fixed joint hinge stand 1002 is adjustable for the recipient to unfold, position and support the one or more than one piece of art.

The holder 202 secures the one or more than one piece of art 104 to the single unit without damaging the piece of art. The one or more than one piece of art 104 is attached to the greeting card 102 using a set of foam holders that are placed to secure each respective piece of art 104 in place within the greeting card, the package, or both the greeting card 102 and the package. The one or more than one piece of art 104 is replaceable into the holder. The one or more than one piece of art 104 is held within a sleeve 802 located on the front of the greeting card 102 portion of the single unit. The sleeve 802 comprises a flap to ensure the one or more than one piece of art 104 cannot slide out of the sleeve 802 after being removed from the package. The one or more than one piece of art 104 comprise a predetermined format, wherein the predetermined format follows manufacturing of a standard greeting cards and package 108 for each respective piece of art. The one or more than one piece of art 104 is held within a sleeve 802 located on an inside front portion of the greeting card 102.

A method for using a combination greeting card and sculpture 100 deliverable as a single unit, the single unit comprising: first receiving a greeting card 102 by an intended recipient. Then, the recipient opens the envelope, and reads the greeting card 102 that conveys the sender's emotional intent that are conveyed from the greeting card 102 to the recipient. Next, the recipient removes the sculpture 104 from the greeting card 102 along with any stand 204 that is also inside of the envelope. Then, the recipient can now appreciate the sentiment originating from the greeting card 102 in the form of a sculpture 104 which they can place wherever they desire. Finally, the recipient can revisit the emotions created more frequently than they could have with a traditional card.

### DETAILED DESCRIPTION OF THE INVENTION

The present invention overcomes the limitations of the prior art by providing a combination greeting card and sculpture 100 deliverable as a single unit (the “greeting card”).

The greeting card 102 of the present invention overcomes the prior art of just being just a card, because it now comprises a piece of art. Art that is attached and detachable from the greeting card 102 that associates an individualized meaning and emotion by a sender to a recipient. The greeting card 102 essentially individualizes and personalize the experience and emotion for the sender to the recipient. The attached piece of art 104 becomes the recipient's. The art becomes valuable because it creates an emotion in the recipient that lasts far longer than any card and can be displayed anywhere for extended periods of time.

Many pieces of quality art are capable of creating an emotional link when combined with the greeting card's words. Without having to be a writer or an artist, the present invention provides the average sender with a premade vehicle for expressing the sender's appreciation and emotion, or whatever emotion the sender desires to anyone, that will last beyond the usual life of a currently available greeting card 102. Once given, the recipient, then, can separate the greeting card 102 from the sculpture 104 and can place that emotion-producing art piece wherever the sender wants.

The human mind has a tendency to associate emotions with things that are initially experienced together. The recipient of the greeting card 102 will experience it along with the greeting card 102 where the sender has placed their sentiment. The emotions of from the greeting card 102 will now be associated with the greeting card 102 making it more individualized and special to the recipient. However, now the recipient can place the art wherever the recipient desires.

Just as people purchase small pieces of art to decorate or personalize their spaces, the combination greeting card and sculpture 100 deliverable as a single unit provides a relatable, more permanent experience for both the recipient and the sender. The present invention surpasses the inherent fate that the current cards can not escape.

All dimensions specified in The disclosure are by way of example only and are not intended to be limiting. Further, the proportions shown in these figures are not necessarily to scale. As will be understood by those with skill in the art with reference to The disclosure, the actual dimensions and proportions of any system, any device or part of a system or device disclosed in The disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in The disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

In the following description, certain terminology is used to describe certain features of one or more embodiments of the invention.

The term “greeting card” refers to a holiday card, a poster, or the like, that includes a removable three-dimensional object and an optional stand 204 for the three-dimensional object.

The term “sculpture” also referred to as a “piece of art” refers to works of art collectively or individually made from carving, modeling, welding, or otherwise producing figurative or abstract works of art in two or three dimensions, as in relief, intaglio, or in the round.

The term “stand” refers to any device for supporting a piece of art, whether it is a flat surface stand, a magnetic attachment, a hanging attachment, etc.

Various embodiments provide a combination greeting card and sculpture 100 deliverable as a single unit. One embodiment of the present invention provides a combination greeting card and sculpture 100 deliverable as a single unit. In another embodiment, there is provided a method for using the combination greeting card and sculpture 100 deliverable as a single unit. The combination greeting card and sculpture 100 deliverable as a single unit and its method will now be disclosed in detail.

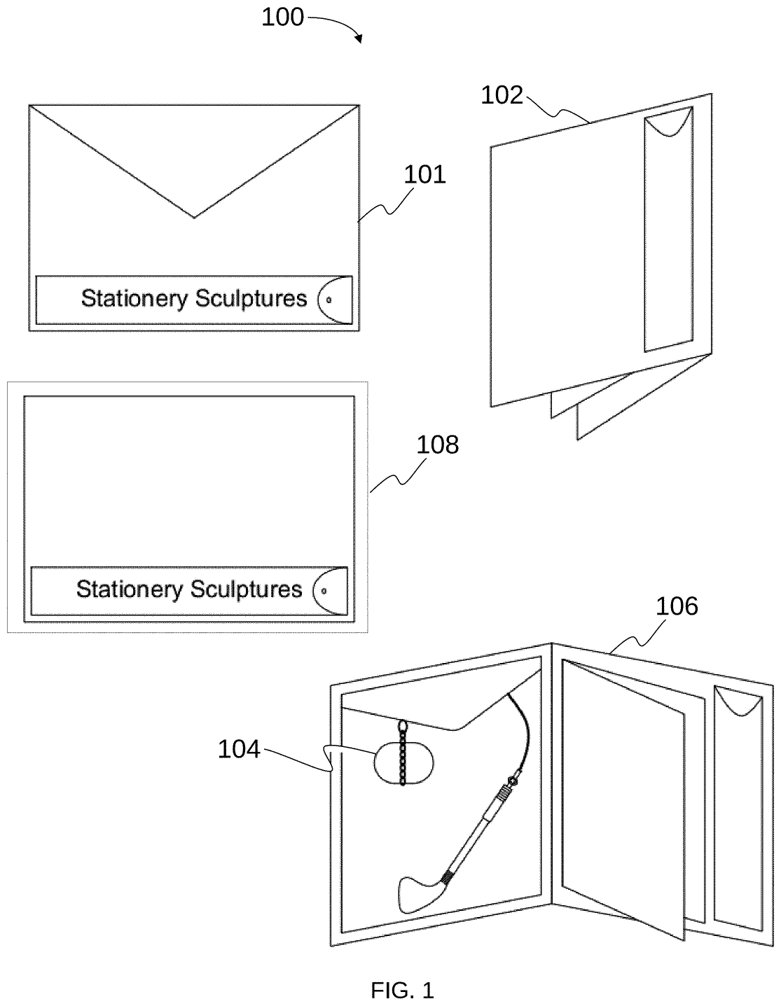

Referring now to FIG. 1, there is shown a drawing of a combination greeting card and sculpture 100 deliverable as a single unit, according to one embodiment of the present invention. As can be seen in, a piece of art 104 is attached to a greeting card 102 to keep the piece of art 104 in place. Although a golf club and ball sculpture 104 is depicted in this exemplar, the piece of art 104 is variable and none of the embodiments shown is meant to be limiting. The piece of art 104 can depict anything so long as it fits within the perimeter of the greeting card 102 and inside of an envelope.

Many pieces of art are capable being displayed without a stand 204 of their own. However, optionally, some of the pieces of are will require a stand 204 or a similar device to position the piece of art 104 on a surface, or to hang. The stand 204 is delivered with each piece of art 104 that requires a stand. If the piece of art 104 has two or more components that require a stand, the greeting card 102 will have a stand 204 for each piece. The stand 204 will hold the piece of art 104 in position when the piece of art 104 is removed from the greeting card 102. Other types of stands are also contemplated, these include, but are not limited to, a magnet, a foldable display case, a pin (for cloth surfaces or cork boards), etc. Additionally, the greeting card 102 itself is not limited to folded items or folded cards.

An aspect differentiating the present invention from the current art is the longer “shelf life” or use time than traditional cards. A combination greeting card and sculpture 100 deliverable as a single unit is timeless, because it is intended to be stand-alone art personalized to the recipient. What is inside of the greeting card, e.g., the sentiment, the signatures, the emotions conveyed by the sender, are what make the greeting card 102 valuable. But eventually most cards are put aside or placed in a special place with other valuable memories.

The present invention is different in that the foundation of the value felt from the recipient is not from the art itself, although there will be a “wow-factor” associated with receiving the novel gift, but the valuable feelings conveyed by the piece of art 104 associated with the greeting card 102 and the piece of art 104. Whenever the recipient sees the piece of art 104, a memory association is triggered so the recipient can remember the greeting card 102 and the sender. This is true of all art. Art gains value by its ability to stir or create an emotion in the viewer. The present invention can create an emotional attachment.

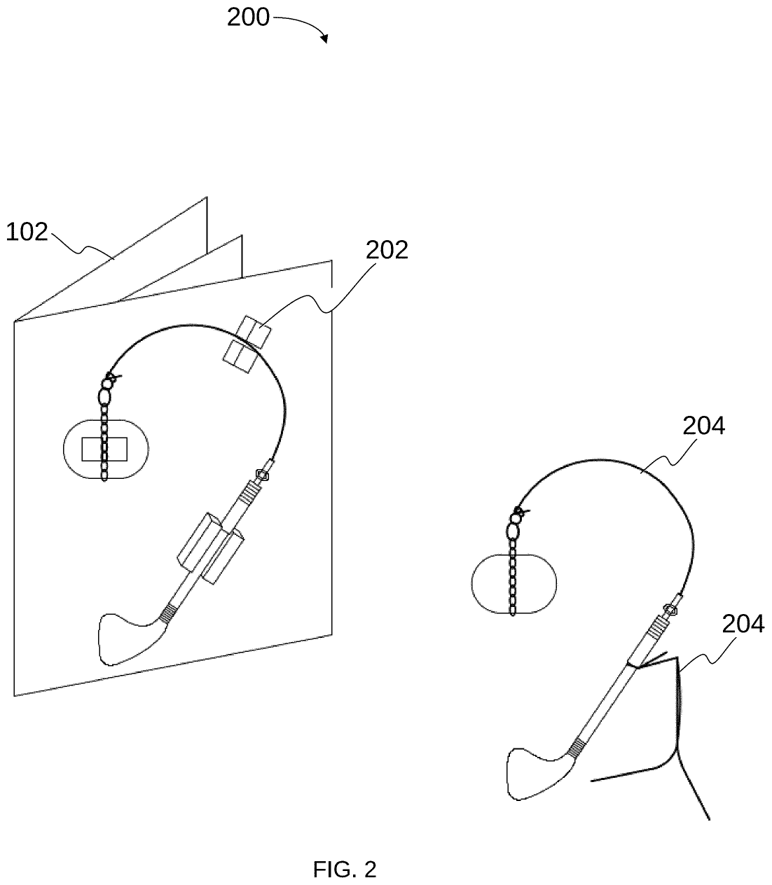

Referring now to FIG. 2, there is shown a second drawing 200 of a combination greeting card and sculpture 100 deliverable as a single unit according to another embodiment. The one or more than one piece of art 104 should be able to be supported by small rectangular shaped pieces of foam 202 on either side of the one or more than one piece of art 104 as shown. As can be seen, the foam 202 is shaped to support and keep the one or more than one piece of art 104 in a static position during transport. Each of the foam 202 pieces can be of various sizes and shapes to perform this function. However, most of the one or more than one piece of art 104 should be able to be supported by small rectangular shaped pieces of foam 202 on either side of the one or more than one piece of art 104 as shown.

The foam 202 blocks are placed to secure each respective piece of art 104 in place. The foam 202 material is only one example of what can be used to secure the piece of art 104 to the greeting card 102. Other securing methods are contemplated below, and there are many others that will be understood by those with skill in the art with reference to this disclosure. The essential function is to secure the piece of art 104 in place without damaging the piece of art. The piece of art 104 should be able to be replaced into the mounts if desired, so The is not meant to be a one-time use type of mount.

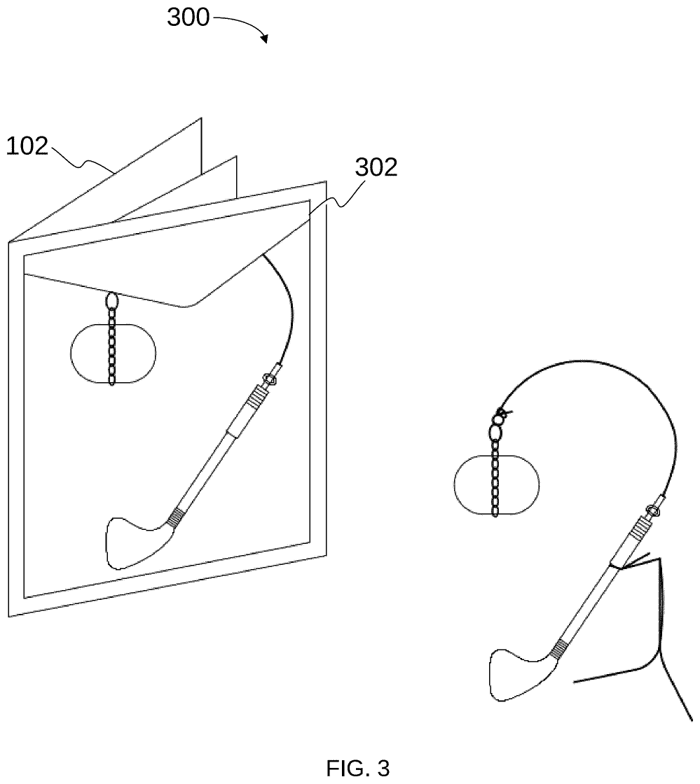

Referring now to FIG. 3, there is shown a third drawing 300 of a combination greeting card and sculpture 100 deliverable as a single unit according to another embodiment. In this embodiment, the piece of art 104 is held within a envelope 302 located on the inside front of the greeting card 102. The envelope 302 will have a flap to ensure the piece of art 104 cannot slide out of the envelope 302 until after being removed from the envelope by the recipient. The envelope 302 in this embodiment limits the options of decoration that can be used on the greeting card 102 to compliment the piece of art, but the envelope 302 provides some practical considerations that can be beneficial. For example, the envelope 302 can be a universal shape with all pieces of art that comply with a predetermined format. The predetermined format allows for the manufacturing of greeting cards that are standardized rather than having individual foam mount patterns for each respective piece of art.

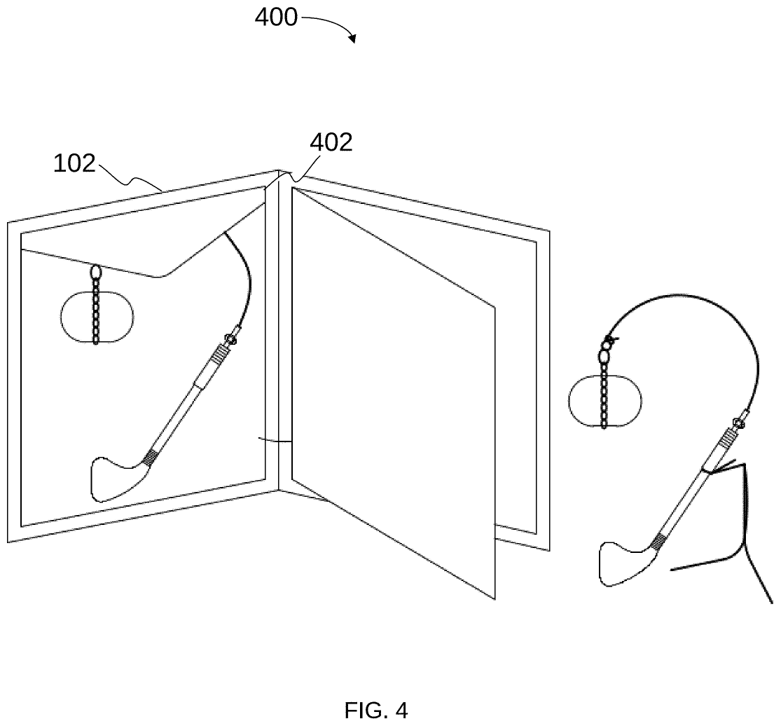

Referring now to FIG. 4, there is shown a fourth drawing 400 of a combination greeting card and sculpture 100 deliverable as a single unit according to another embodiment. In this embodiment, the optional stand, that is essential to a piece of art 104 that cannot stand on its own, is stored in a separate envelope 402 on the front, inside or in multiple locations on the greeting card 102 as required by the piece of art. For example, a multi-piece art work can require more than one stand or support to display the complete piece of art, and multiple envelopes may be required.

The position of the stand envelope 402 can be on the front, inside, or back based on the envelope or on the greeting card 102 itself. If the stand 204 is placed in the envelope 402, this would require the envelope 402 to become proprietary. Having the stand envelope 402 on the exterior portion of the greeting card 102 or on the greeting card package 108 provides more space inside the greeting card 102 for the piece of art. Additionally, this placement provides space for complimentary designs, and less objects to pose difficulties to writing in the greeting card 102 itself.

As will be understood by those with skill in the art with reference to this disclosure, the provided examples are not the extent to which the envelope 402 can be placed and are not meant to be limiting.

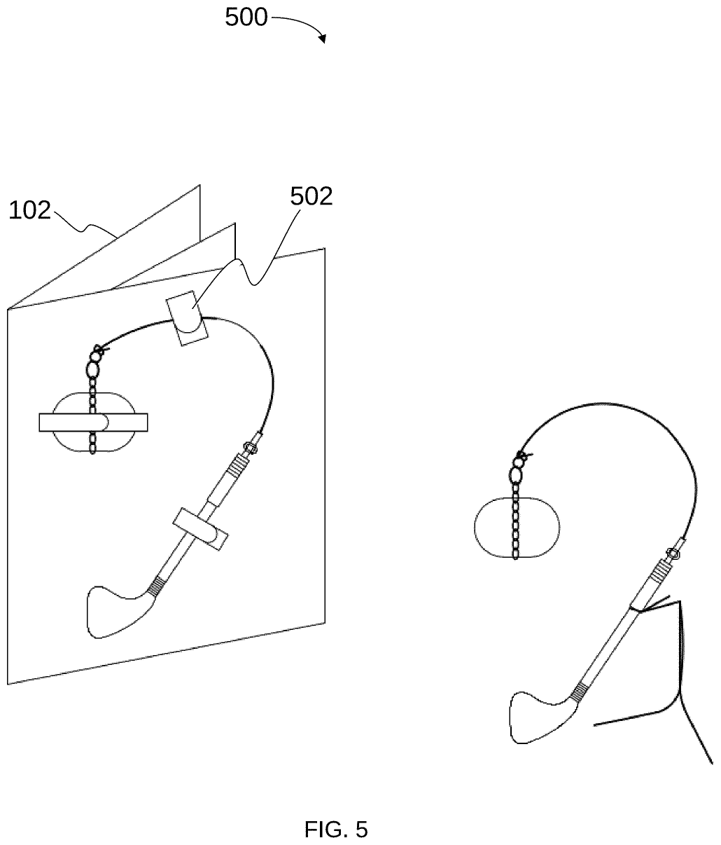

Referring now to FIG. 5, there is shown a fifth drawing 500 of a combination greeting card and sculpture 100 deliverable as a single unit according to another embodiment. In this embodiment, one or more than one hook and loop strap 502 (a.k.a. Velcro©) can be used for attachment of a piece of art 104 to the greeting card 102. The one or more than one hook and loop strap 502 can be affixed to the greeting card 102 in various places in order to secure the piece of art 104 to the greeting card 102. The position of the piece of art 104 may vary, such as, for example, on a front side, an inside portion, or a back portion of the greeting card, but the one or more than one hook and loop strap 502 is positioned to secure the piece of art.

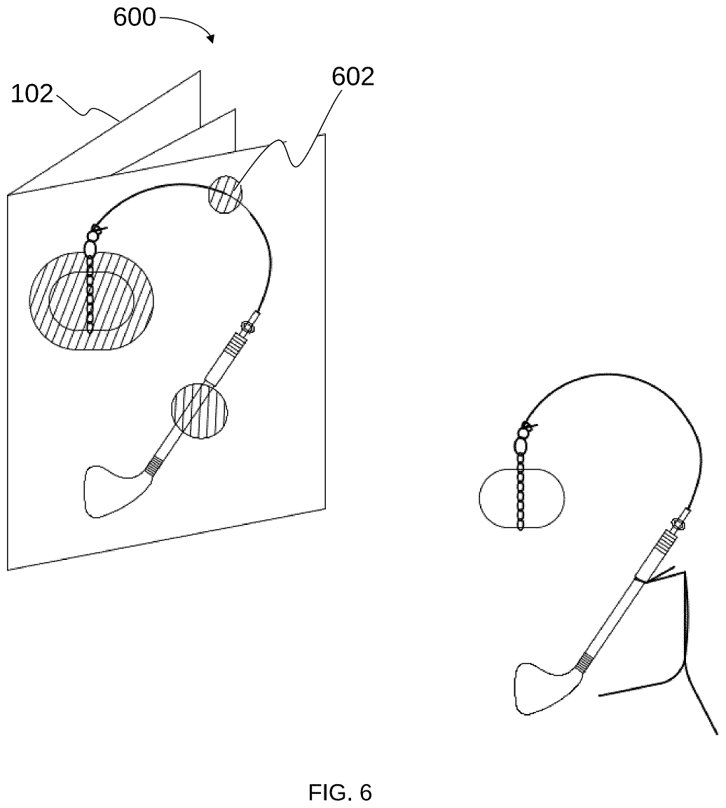

Referring now to FIG. 6, there is shown a sixth drawing 600 of a combination greeting card and sculpture 100 deliverable as a single unit according to another embodiment. In this embodiment, one or more than one adhesive mount 602 provides a more limited function to secure a piece of art. The one or more than one adhesive mount 602 may have a difficult time sticking to enough surface area to create a reliable mount strong enough to hold the piece of art 104 for a significant amount of time. However, there are situations that this option is preferable to other available options for temporarily securing the piece of art 104 to the greeting card 102.

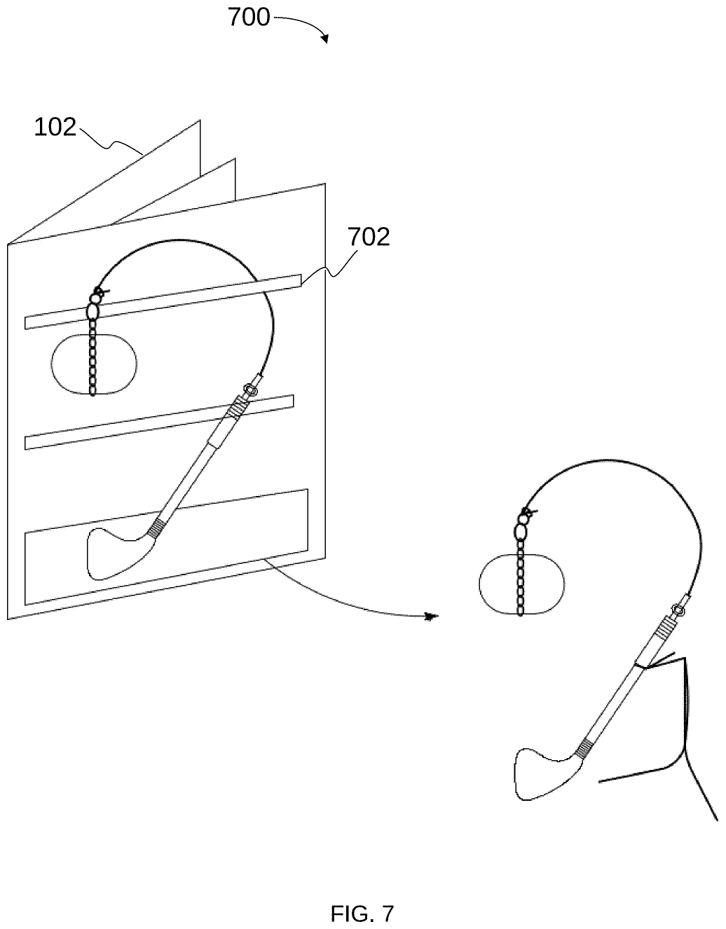

Referring now to FIG. 7, there is shown a seventh drawing 700 of a combination greeting card and sculpture 100 deliverable as a single unit according to another embodiment. In this embodiment, one or more than one elastic band 702, one or more than one plastic strap or both one or more than one elastic band and one or more than one plastic strap are used to hold the piece of art 104 in place on the greeting card 102. The one or more than one elastic band 702 or one or more than one plastic strap are placed strategically on the greeting card 102 to hold the piece of art 104 wherever the best placement for the piece of art 104 is determined. The one or more than one elastic band 702 or one or more than one plastic strap are reusable, if the recipient wants to replace the piece of art 104 back with the greeting card 102 to keep both items.

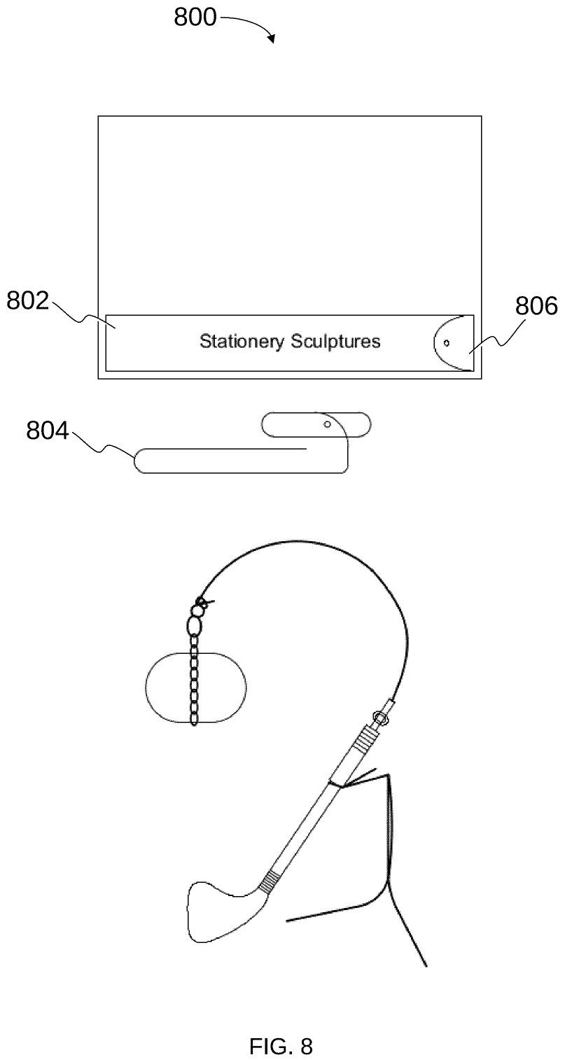

Referring now to FIG. 8, there is shown an eighth drawing 800 of a combination greeting card and sculpture 100 deliverable as a single unit according to another embodiment. In this embodiment, the piece of art 104 is meant to be held within a sleeve 802 located on the front of the greeting card 102. The sleeve 802 can also comprises a flap 806 to ensure the piece of art 104 cannot slide out of the sleeve 802 until after being removed from the he envelope. The sleeve 802 does limit the options of decoration that can be used on the greeting card 102 to compliment the piece of art. However, the sleeve 802 provides some practical considerations that can be beneficial. For example, the sleeve 802 is universal with all piece of arts that comply with a particular predetermined format. The predetermined format allows manufacturing of standard greeting cards in stead of individual foam mount patterns for each respective piece of art. Additionally, the sleeve 802 provides an additional “gift unwrapping” experience for the receiver.

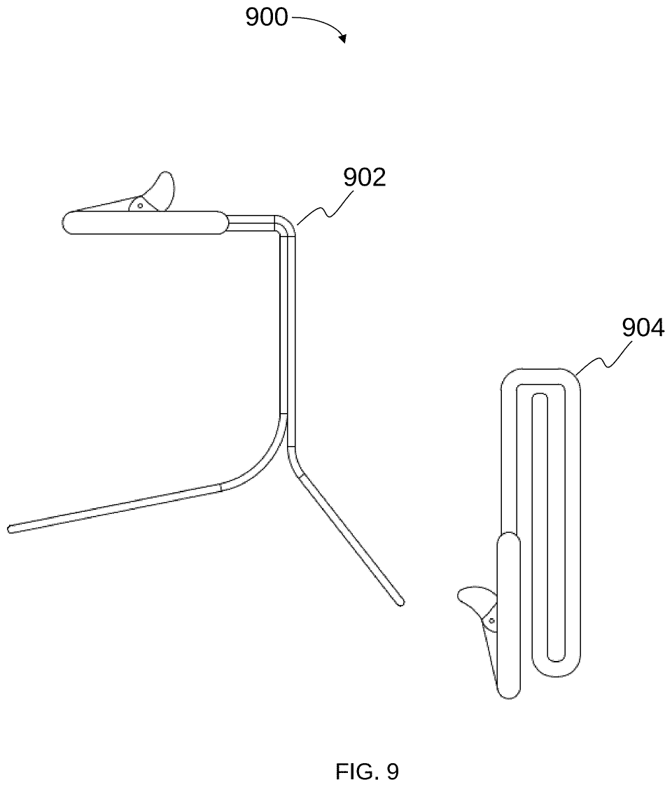

Referring now to FIG. 9, there is shown a second drawing of a stand useful for the combination greeting card and sculpture 100 deliverable as a single unit shown in FIG. 1. This stand assists the piece of art 104 with transcending the limitations experienced by most traditional cards and pop-up designs in the market today. The stand enables the piece of art 104 to be displayed in a variety of different environments based on the particular stand's function. As noted above, there are a variety of different methods for displaying the piece of art 104 attached to the greeting card 102 as will be understood.

The stand can also be as much of a piece of art 104 as the sculpture 104 that is included in the greeting card 102. This provides freedom for an artist/creator to create more expressions in a variety of ways so as to not limit the piece of art 104 by the size of an envelope or the greeting card 102. It is also contemplated that custom art and stands can be requested that are capable of representing anything from a person's individualized wedding, to a business gift for employees, patrons, or others. Special pieces of art and stands can be created specifically for a family, a family member or a friend to create a lasting memory.

The stand shown in this embodiment is a device that helps a sculpture 104 stand on any flat surface the recipient wishes to place the piece of art. It is also possible to create a sculpture 104 that has moving parts and sculptures that can stand on their own without a separate stand. For 2D sculptures a stand is required to display the piece of 2D art on any flat surface. The stand shown here is bendable/foldable so that it occupies the least amount of space in the greeting card 102.

In this embodiment, as with all the other stands described above, are collapsible to fit into a sleeve 802 attached to the greeting card 102, wherever the sleeve 802 is located. The stand is a malleable material 904 that allows the recipient to display a piece of art 104 by shaping the stand 902 into a desired display shape to hold the piece of art 104 in place.

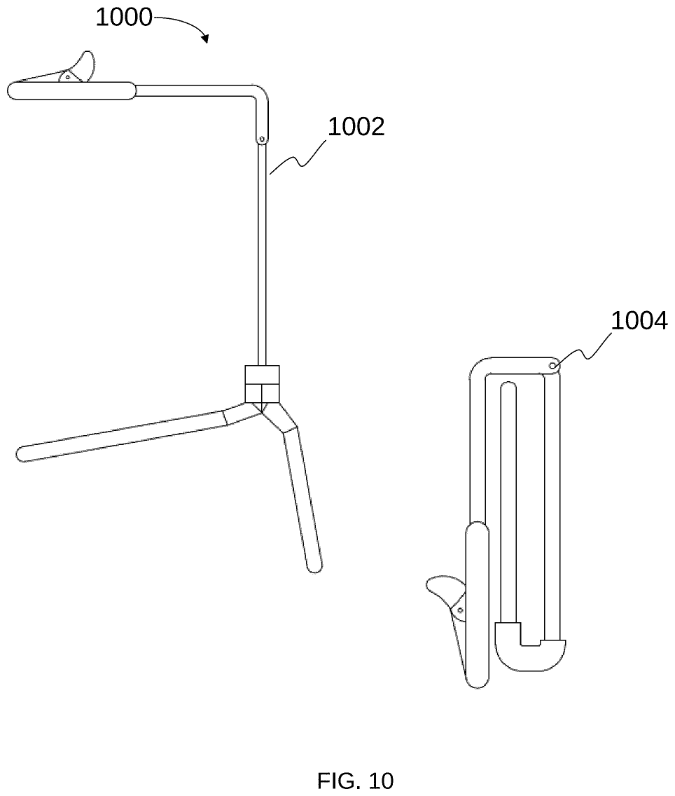

As shown in FIG. 10, Here, there is shown a stand 1002 that comprises one or more than one fixed joint hinge 1004 to support the piece of art. Although more limiting in the number of positions available to the recipient, this embodiment provides more repeatability for the recipient to move the piece of art. The one or more than one fixed joint hinge stand 1002 is more readily adjustable for the recipient to unfold, position and support the piece of art.

Generally, only one version of a stand would be available with each greeting card, but it is possible that more than one stand may be needed for one or more than one piece of art.

As will be understood, the material used for the stand will vary and changes in the geometry of the stand are possible, but the essential function of the stand will be to hold the piece of art 104 while not attached to the respective card.

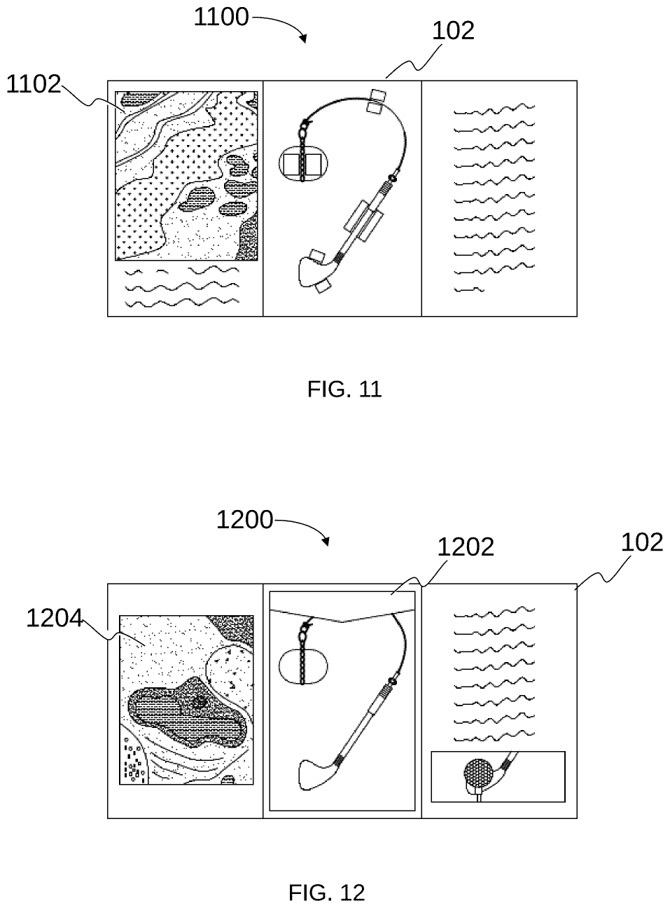

Referring now to FIG. 11, there is shown a drawing 1100 of a single unit using foam to secure the art inside the greeting card 102. The greeting card 102 can be decorated elaborately 1102 to complement the piece of art 104 or it can be a standard color and size functioning as solely as a mount for the piece of art.

Referring now to FIG. 12, there is shown a drawing 1200 of a single unit using an envelope 1202 to secure the art inside the greeting card 102. As can seen, the one or more than one piece of art 104 can be placed inside an envelope 1202 affixed to the greeting card 102. In this embodiment, the envelope is in the middle of a trifold greeting card 102. However, as will be appreciated by those with skill in the art with reference to this disclosure. The envelope 1202 can be affixed to the back of the single fold greeting card 102, or to the inside of a single fold greeting card 102. The envelope 1202 can be affixed to any size and shaped greeting card 102 to be out of the way of the greeting cards message or images 1204.

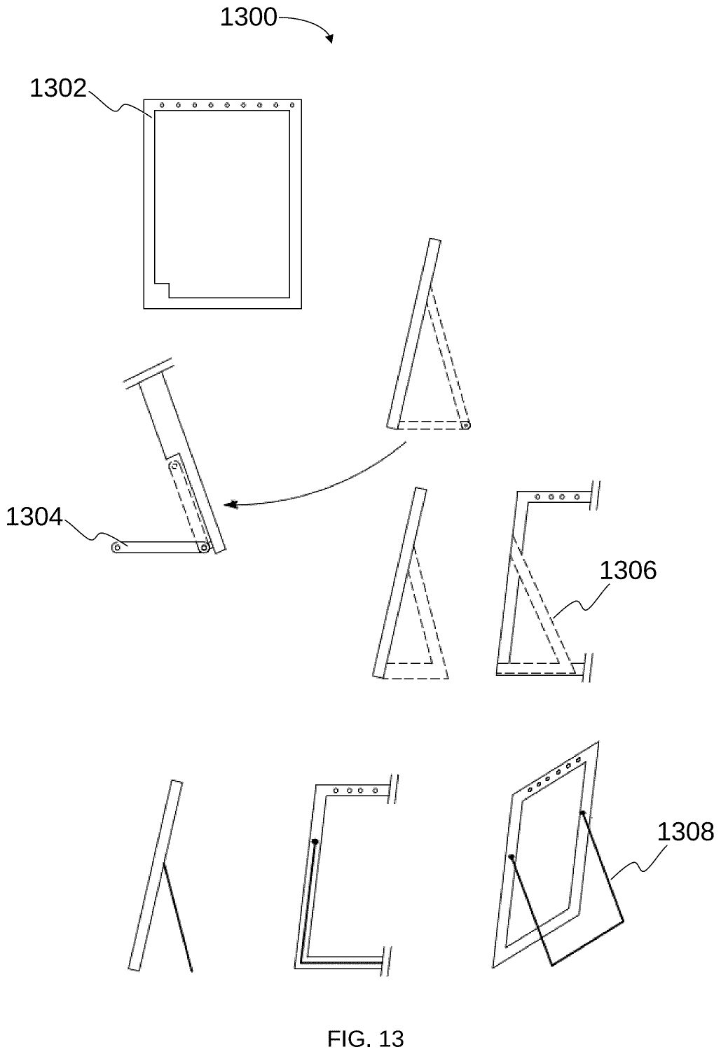

Referring now to FIG. 13, there are shown drawings 1300 of various frame stands 1302, 1304, 1306 and 1308 useful for the combination greeting card and sculpture 100 deliverable as a single unit. As can be seen, the various frames stands 1302, 1304, 1306 and 1308 each start out as a flat frame 1302 and comprise one or more than one retractable support. The supports range from a fold out triangular brace 1306, a hinged arm stand 1304, to a U shaped wire 1308 flip out stand. Other contemplated options include that the frame 1302 is hollow or that the frame comprises a solid backing, depending the choices made by the sender. Optionally, the frame 1302 can comprise a solid backing that is removable by the recipient for even more options.

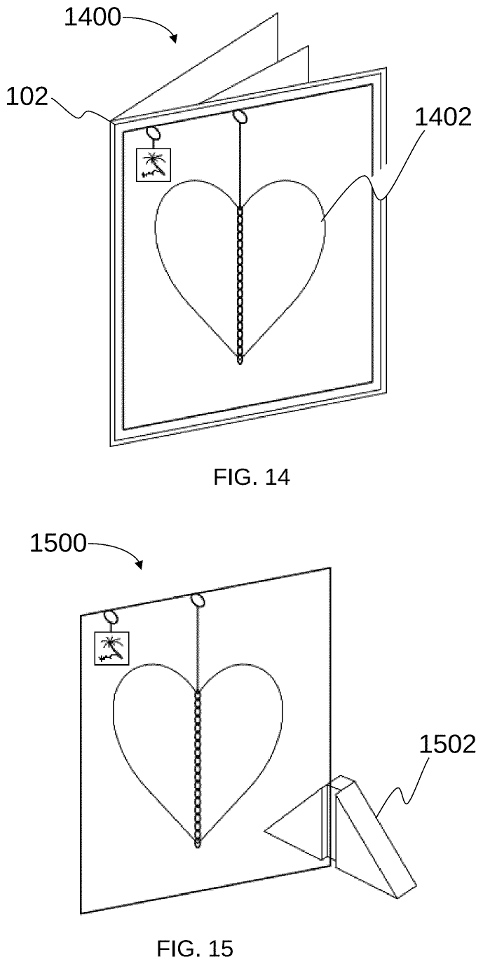

Referring now to FIGS. 14 and 15, there is shown drawings of a two dimensional piece of art 1400 and 1500 useful for the combination greeting card and sculpture 100 deliverable as a single unit. This embodiment is the most closely related to the prior art. However the two dimensional piece of art 1400 and 1500 is detachable from the greeting card 102 portion of the single unit. The two dimensional piece of art 1400 and 1500 can then be hung or placed in a variety of places. Optionally, there is provided a stand 1502 for supporting the two dimensional piece of art 1400 and 1500 so that it may be placed on any flat surface. The two dimensional piece of art 1400 and 1500 can also be hung from one of the stands shown in FIGS. 9 and 10, or be set in one of the various frames shown in FIG. 13.

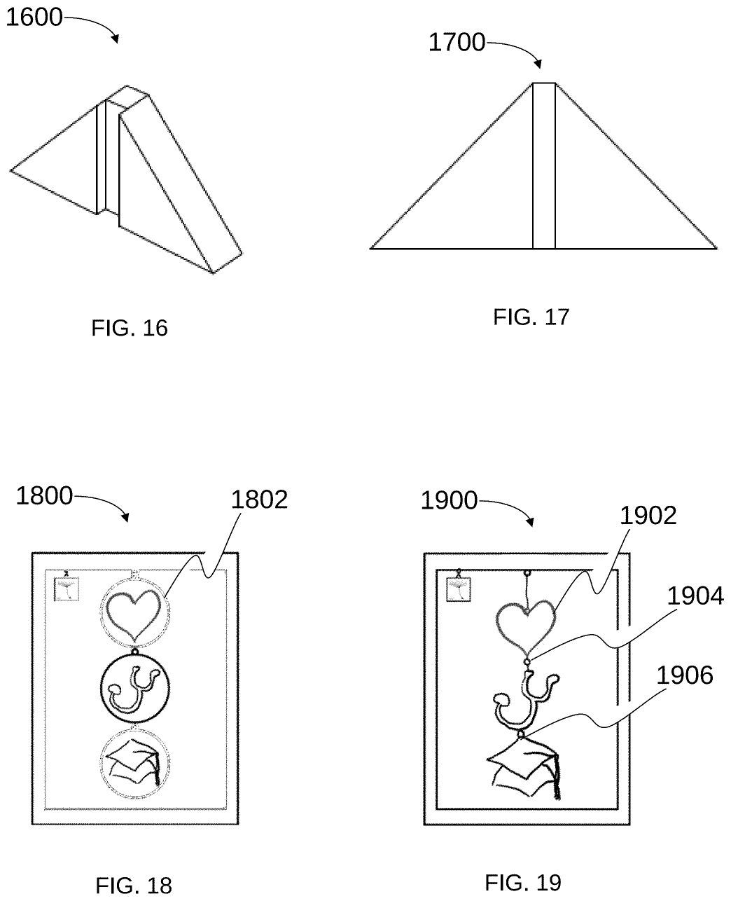

Referring now to FIGS. 16 and 17, there is shown drawings of a perspective view 1600 and a front view 1700 of a stand useful for the combination greeting card and sculpture 100 deliverable as a single unit. As can be seen, this stand is more substantial in width compared to the previously described stands. This provides additional support for any of the one or more than one piece of art 104 that requires the extra support. For the purposes of sending the single unit through the mail, this stand 1600 and 1700 can be made from a stiffer material that can be folded when the single unit is received. In other embodiments, the stand is sufficiently compact that it can be included in the single unit as constructed. In this case, the stand 1600 and 1700 is made of more solid materials that can withstand the rigors of mail handling without losing its shape.

Referring now to FIG. 18, there is shown a drawing 1800 of a relief charm 1802 useful for the combination greeting card and sculpture 100 deliverable as a single unit. This piece of art 104 comprises reliefs sculpted onto a circular background. This type of relief charm 1802 can be custom ordered by the sender to reflect more personal connections with the recipient. One or more than one relief charm 1802 can be set in a frame, such as the frames shown in FIG. 13. In this embodiment, the relief charms 1802 are circular, however, it is contemplated that one or more than one relief charm 1802 can comprise a shape, and be made from any material.

Referring now to FIG. 19, there is shown a drawing 1900 of a sculptured charm 1902 useful for the combination greeting card and sculpture 100 deliverable as a single unit. In this embodiment, there are one or more than one sculptured charm 1902 that can be linked together, like the relief charms 1802 above, to allow the sender to relay more than one memory significant to the recipient. Each sculpted charm 1902, can be set in a frame 1302-1308, similar to the frames shown in FIG. 13, or displayed using one of the stands 900 and 1000 shown in FIGS. 9 and 10. The same is true for the relief charms 1802 described above. This provides the sender with multiple options to send the one or more than one sculpted charm 1902 to the recipient. In one embodiment, the sculpted charm 1902 would be comprised of enamel and made in the shape of the item being depicted. Each of the enamel shaped sculpted charms 1902 would also comprise an eyelet 1904 and a hook 1906 so that each sculpted charm 1902 can be hung together. This makes it possible for the sender to send multiple charms at different times to construct a continuous memory stream for the recipient. The same eyelet 1904 and hook 1906 are also present in the relief charms 1802 and any other contemplated charm.

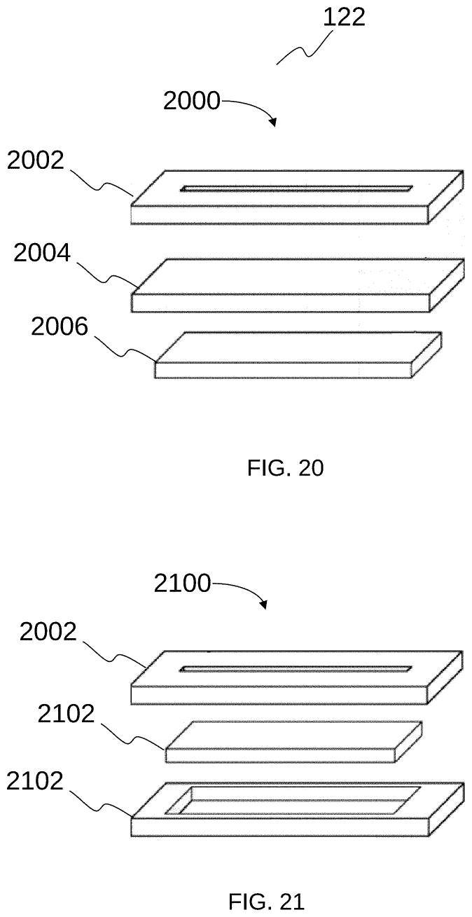

Referring now to FIGS. 20 and 21, there is shown drawings of a clamp stand 2000 and 2100 useful for the combination greeting card and sculpture 100 deliverable as a single unit. For certain pieces of art, a base is more appropriate for displaying the one or more than one piece of art 104. In these cases there is provided the shown in the FIGS. 2000 and 2100. The clamp stand 2000 comprises a bottom base 2006, a middle base 2004 and a slit base 2002. The one or more than one piece of art 104 will sit on the middle base 2004 and the slit base 2002 will slip over the one or more than one piece of art 104 and “clamp” a base 2006 of the one or more than one piece of art 104 between the middle base 2004 and the slit base 2002 forcing the one or more than one piece of art 104 to an upright position. The bottom base 2006 is used to add additional weight to the clamp stand 2000 and 2100 for those pieces of art 104 that are more top heavy, such as, for example, a willow tree sculpture. As shown in FIG. 21, there is a variation of the clamp stand 2100 described above, wherein the middle base 2100 comprises the weighted portion and the bottom base 2102 comprises an opening sized to the middle base 2102. This embodiment reduces the size of the clamp stand 2100. The bases 2006 and 2102 that comprise the clamp stand 2000 and 2100 can be held together with glue, Velcro®, magnets, and any other method known in the art. The clamp stands 2000 and 2100 can also be made of any material that is sufficiently rigid enough to support the sculpture 104 and stand up to the rigors of mail handling.

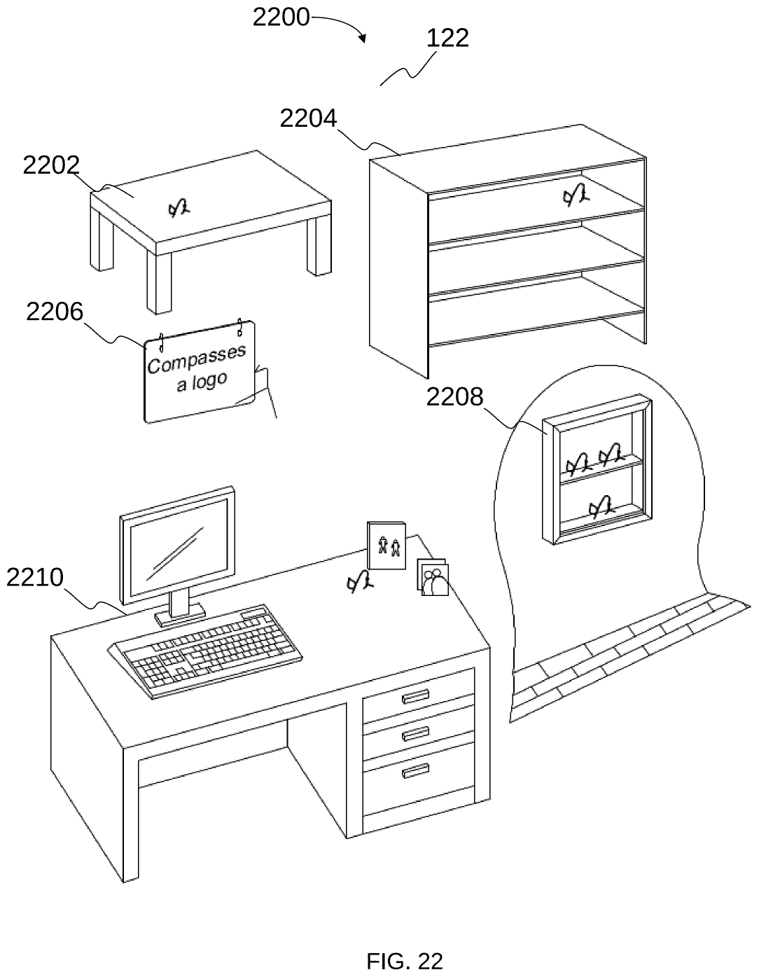

Referring now to FIG. 22, there is shown a drawing 2200 of possible placements for one or more than one piece of art 104 removed from the combination greeting card and sculpture 100 deliverable as a single unit. Depending on the stand and/or the one or more than one piece of art, the recipient can place the received one or more than one piece of art 104 anyplace that the recipient desires, such as:

a bookshelf 2204

a desk 2210

a dresser

a pantry 2206

a coffee table 2202

a shadow box 2208

The piece of art 104 depicted here can be placed anywhere the recipient would want to share the piece of art 104 and the emotion attached to it with others. The present invention surpasses the desire to remove the card from a public or a private space and place it aside where previously received cards are stored to be revisited only when the mood strikes. The piece of art 104 attached to the greeting card 102 is meant to remain out. It is more art than novelty.

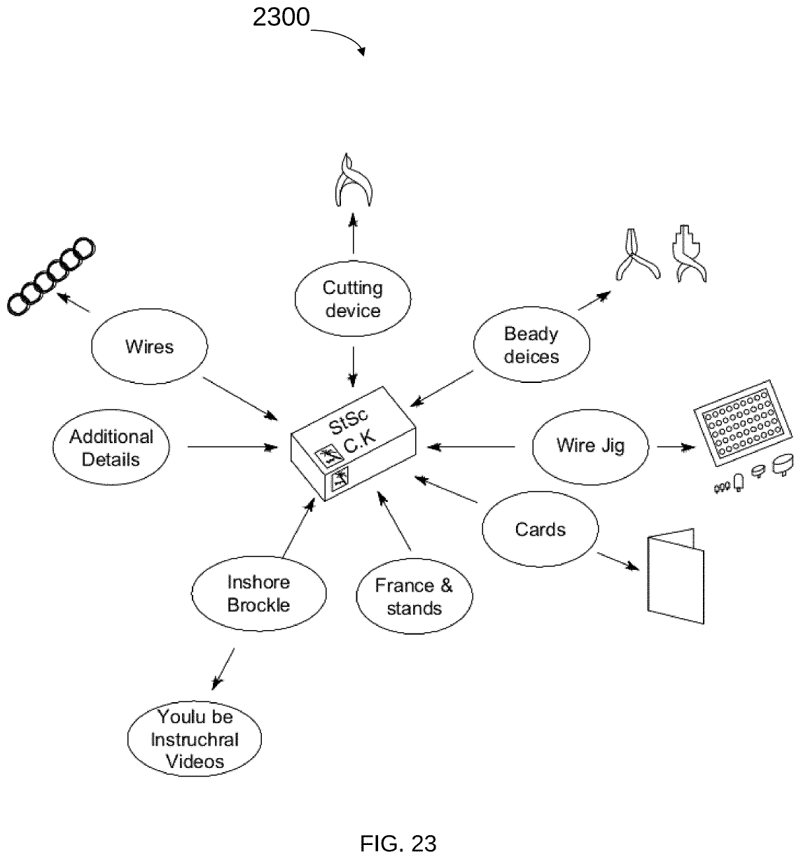

Referring now to FIG. 23, there is shown a drawing of a kit 2300 for making a combination greeting card and sculpture 100 deliverable as a single unit. There is also contemplated a kit 2300 for more artistically inclined customizations of the single unit. The kit 2300 comprises all the materials needed to make one or more than one single unit, one or more than one piece of art 104 and one or more than one greeting card 102 and one or more than one package 108 options for sending the completed single unit. The kit 2300 allows intense customization of the message and the art sent to the recipient. How many parents, grand parents, and other relatives have memories of the children they love and would cherish a handmade piece of art 104 and greeting card? Refrigerators, walls, office desks, and other places are adorned with paintings and other “art” made by children. The kit 2300 provides a way to make a more permanent, less temporary piece of art, that can be cherished for years to come and can easily be transported from place to place.

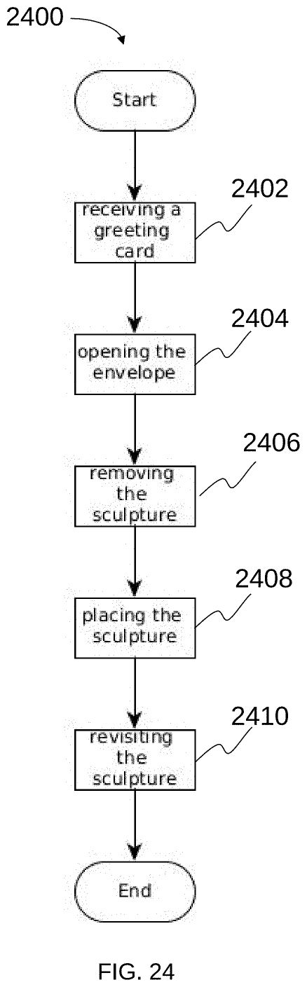

Referring now to FIG. 24, there is shown a flowchart diagram 2400 of some steps of a method for using the combination greeting card and sculpture 100 deliverable as a single unit. There is also provided a method for using a combination greeting card and sculpture 100 deliverable as a single unit, the method comprising the steps of: receiving 2402 a greeting card 102 by an intended recipient. Then, the recipient opens 2404 the envelope, and reads the greeting card 102 that conveys the sender's emotional intent that are conveyed from the greeting card 102 to the recipient. Next, the recipient removes 2406 the sculpture 104 from the greeting card 102 along with any stand that is also inside of the envelope. Then, the recipient can now appreciate the sentiment originating from the greeting card 102 in the form of a sculpture 104 which they can place 2408 wherever they desire. Finally, the recipient can revisit 2410 the emotions created more frequently than they could have with a traditional card.

What has been described is a new and improved system for a combination greeting card and sculpture 100 deliverable as a single unit, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in The disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A combination greeting card and sculpture deliverable as a single unit, the single unit comprising:
a. a package;
b. a greeting card insertable into the package;
c. a holder attached to the greeting card, the package or both the greeting card and the package;
d. one or more than one piece of art personalized to the recipient that is attachable and detachable from the greeting card that is displayed at any location for extended periods of time; and
e. one or more than one art stand attachable and detachable from the greeting card for supporting the one or more than one piece of art.

2. The single unit of claim 1, wherein the package is selected from the group consisting of a folder, an insulated envelope, an envelope, or a box.

3. The single unit of claim 1, wherein the greeting card individualizes and personalize the experience and emotion for the sender to the recipient, wherein the one or more than one piece of art becomes the recipient's.

4. The single unit of claim 1, wherein the greeting card is separate from the sculpture and is placed at a desired location by the recipient as a reminder of emotions associated with the greeting card making it more individualized and special to the recipient.

5. The single unit of claim 1, wherein the stand for supporting one or more than one piece of art is selected from the group consisting of a flat surface stand, a magnetic attachment, a hanging attachment, or a self adhesive wall mount.

6. The single unit of claim 1, wherein the holder secures the one or more than one piece of art to the single unit without damaging the piece of art.

7. The single unit of claim 18, wherein the one or more than one piece of art is attached to the greeting card using a set of foam holders that are placed to secure each respective piece of art in place within the greeting card, the package, or both the greeting card and the package.

8. The single unit of claim 7, wherein the one or more than one piece of art is replaceable into the holder.

9. The single unit of claim 1, wherein the stand is provided for each piece of art that requires a stand, wherein if the piece of art has two or more components that require a stand, the single unit will have a stand for each piece.

10. The single unit of claim 1, wherein the stand is selected from the group consisting of: a magnet, a foldable display case, a pin, a hook, hook and loop, one or more than one elastic bands, one or more than one plastic straps, one or more than one wire tie, tape, or an adhesive.

11. The single unit of claim 1, wherein the one or more than one piece of art is held within a sleeve located on the front of the greeting card portion of the single unit.

12. The single unit of claim 11, wherein the sleeve comprises a flap to ensure the one or more than one piece of art cannot slide out of the sleeve after being removed from the package.

13. The single unit of claim 1, wherein the one or more than one piece of art comprise a predetermined format, wherein the predetermined format follows manufacturing of a standard greeting card and package for each respective piece of art.

14. The single unit of claim 1, wherein the one or more than one piece of art is held within a sleeve located on an inside front portion of the greeting card.

15. The single unit of claim 1, wherein the stand and/or the one or more than on piece of art are attached to the greeting card with one or more than one hook and loop strap.

16. The single unit of claim 1, wherein the stand is also a piece of art to complement the one or more than one piece of art.

17. The single unit of claim 1, wherein the stand is bendable/foldable to occupy the least amount of space or is collapsible to fit into a sleeve attached to the greeting card.

18. The single unit of claim 1, wherein the stand comprises one or more than one fixed joint hinge to support the one or more than one piece of art, wherein the one or more than one fixed joint hinge stand is adjustable for the recipient to unfold, position and support the one or more than one piece of art.

19. A combination greeting card and sculpture deliverable as a single unit, the single unit comprising:
a. a package;
b. a greeting card insertable into the package; and
c. one or more than one piece of art attachable and detachable from the greeting card capable being displayed without a stand.

20. A method for using a combination greeting card and sculpture deliverable as a single unit, the single unit comprising, the method comprising the steps of:
a. receiving a greeting card by an intended recipient;
b. opening the envelope, and reads the greeting card that conveys the sender's emotional intent that are conveyed from the greeting card to the recipient;
c. removing the sculpture from the greeting card along with any stand that is also inside of the envelope;
d. appreciating the sentiment originating from the greeting card in the form of a sculpture which the recipient can place wherever the recipient desires; and
e. revisiting the emotions created more frequently than they could have with a traditional card.
